(19) United States
(12) Patent Application Publication
(10) Pub. No.: US 2025/0369499 A1
(43) Pub. Date: Dec. 4, 2025

(54) GRAVITY COMPENSATION DEVICE

(71) Applicant: Precitrame Machines SA, Tramelan (CH)

(72) Inventors: David Haag, Plagnes (CH); Pierre Goujon, Neuchâtel (CH)

(73) Assignee: Precitrame Machines SA, Tramelan (CH)

(21) Appl. No.: 19/225,881

(22) Filed: Jun. 2, 2025

(30) Foreign Application Priority Data
Jun. 3, 2024 (EP) 24179660.6
Aug. 8, 2024 (EP) 24193661.6

(51) Int. Cl. F16F 15/14

(52) U.S. Cl. CPC F16F 15/145; F16F 2222/08; F16F 2232/02; F16F 2236/08

(57) ABSTRACT

The invention concerns a gravity compensation designed to compensate for the unbalance of a rotating element (1) pivoted on a support (4). The device comprises a compensating mobile (2) pivotally mounted on the support (4) and kinematically connected to the rotating element (1). The device also comprises an elastic return element (3), a first end of which is mounted directly on the compensation mobile (2), eccentrically, to exert on the compensation mobile a force whose intensity and lever arm vary as a function of the angular position of the rotating element. In an original way, a second end of the elastic return element (3) is mounted on the support (4) or on a second compensating mobile (2) pivotally mounted on the support (4) and kinematically connected to the rotating element (1), the characteristics of the device being chosen so that the resulting torque on the rotating element compensates, over a functional angular range, for the torque due to the unbalance.

### TECHNICAL FIELD

The present invention relates to a gravity compensation device, in particular for a machine tool or measuring machine. More particularly, it relates to a device for compensating the unbalance of a rotating element of such a machine. The invention also relates to a machine tool or measuring machine comprising such a device.

### PRIOR ART

Numerous devices are known for compensating for the effects of gravity on a moving part that is not balanced on its axis of rotation.

U.S. Pat. No. 4,768,762 describes a device for compensating the weight of a rotating mobile by means of a spring attached to a band winding around a cam integral with the mobile. The torque exerted by the weight of the mobile varies according to a sinusoidal function of the angle formed between the vertical and the straight line passing through the axis of rotation of the mobile and its center of gravity. The return force of the spring varies as a function of its elongation. The cam profile is designed so that the return torque exerted by the spring compensates for the weight of the mobile as a function of the angle of the mobile and the elongation of the spring.

Document U.S. Pat. No. 4,500,251 discloses a robot comprising a device for compensating the weight of an end segment pivoted around an intermediate segment itself pivoted on a frame. A first wheel pivoted on the frame, on the same axis of rotation as the intermediate segment, is connected, by a chain or toothed belt, to a second wheel of the same diameter, integral and coaxial with the end segment, in such a way that, since the two wheels always have the same orientation, the angular position of the first wheel relative to the frame corresponds to the angular position of the end segment relative to the frame, independently of the angular position of the intermediate segment. A spring is fixed between the frame and the first wheel to exert a restoring torque compensating for the unbalance of the end segment. When the end segment is in the vertical position, the spring's restoring force passes through the axis of the first wheel and the restoring torque is zero. Conversely, the lever arm and restoring torque are at their maximum when the end segment is in the horizontal position. To ensure that variations in the orientation and intensity of the restoring force remain low, and that the restoring torque approaches the purely sinusoidal function of the unbalance, it is important that variations in spring tension and orientation remain low. To achieve this, its attachment point to the frame must be as far away as possible. The use of two linked wheels of the same diameter enables information on the orientation of the end segment and the compensation torque to be transmitted. It would not be possible to attach the spring directly to the intermediate segment, whose orientation varies. The robot could be equipped with any number of segments, using a series of identical links to transmit the orientation information of the end segment to the frame.

In these first two compensation mechanisms, the considerable length of the return spring makes it impossible to envisage the integration of these systems in the limited space of machine tools, particularly if the support on which it is mounted is itself mobile. In addition, the action of a force directly on the rotating element, which includes an unbalance to be compensated for, induces a force with a radial component on the axis of rotation, which adversely affects the positioning accuracy of the rotating element and causes premature wear of the pivot.

Document US20100294173 discloses a gravity compensation mechanism for a machine-tool oscillating table. Two pinions of the same size mesh to rotate in opposite directions at the same speed. The two pinions are pivoted on a frame, one of which is integral with the oscillating table. A constant compressive or tensile force is applied between two pins fixed to each pinion, using various devices: a hydraulic cylinder, a pneumatic piston, a spring with one end mounted on a winder so that its length does not vary, a weight and pulley system.

Document JP2000301405 describes another mechanism for compensating the gravity of a machine-tool tilting table. The end of a cylinder acts on a crank kinematically connected to the table to compensate for the table's imbalance. For reasons of space in the vicinity of the table's axis of rotation, the crank is not directly attached to the table, but is mounted on an offset mobile, connected to the table by a transmission belt or gear with a drive ratio of one to one.

Document U.S. Pat. No. 2,584,921 describes a mechanism for counteracting the unbalance of a rotating element such as a crane jib oscillating between 0 and 180° with reference to a vertical direction. A first end of a spring is attached to a pivoting mobile kinematically linked to the rotating element by a chain meshing with two sprockets of the same diameter. The second end of the spring is connected to a cable winding onto a drum on the rotating element. In the 90° to 180° angular range of the rotating element, the restoring torques exerted by the spring on the drum and the pivoting mobile are both opposite to the torque due to the unbalance and are proportional to the spring elongation. In the 0 to 90° range, spring elongation and the return torque exerted on the drum vary little, and the torque exerted by the pivoting mobile is in the same direction as the torque due to the unbalance. This device is limited to an angular range of 0° to 180° for the rotating element and is not suitable for a titling table of a machine tool, which typically pivots from −110° to +110°. In addition, in order for spring orientation variations to be negligible, the pivoting mobile must be located at a distance from the rotating element, which makes the device not very compact.

U.S. Pat. No. 8,220,765 describes a mechanism for compensating the unbalance of a rotating element on a support. A first flexible strand is wound around three pulleys, one of which is pivotally mounted on the rotating element. A return spring has one end attached to the support, the other to a second strand. The first and second strands are attached to the same pulley so that rotation of the rotating element causes rotation of this pulley, elongation of the spring and tensioning of the first and second strands, generating a return torque on the movable pulley mounted on the rotating element. The torque generated perfectly compensates for the sinusoidal torque due to the unbalance. However, this system is cumbersome and not easily integrated into a constrained environment.

All these mechanisms present various disadvantages in terms of size, complexity, reliability and inertia, particularly when the support on which the rotating element is mounted is itself mobile and when the latter is intended to undergo significant angular accelerations.

Generally speaking, the unbalance of a rotating element on a machine without a compensation device must be supported by the motor driving the rotation of this element. This leads to premature motor wear, increased electricity consumption, motor overheating and thermal distortion, all of which are detrimental to machine precision and require additional cooling. Motor servo-control and regulation are also more delicate in the presence of an unbalance. Finally, working in an unfavorable fixed position close to 90° requires a brake to block rotation of the rotating element. Adding a counterweight to balance the rotating element is not desirable, as this would increase its inertia and impact machining or measuring speed and accuracy.

The aim of the invention is to remedy the various drawbacks of the prior art and to provide a gravity compensation system that is accurate over at least one functional angular range, simple, reliable, compact and low inertia.

### DISCLOSURE OF THE INVENTION

The purpose of the invention is achieved by a gravity compensation device, in particular for a machine tool or measuring machine, designed to compensate for the unbalance of a rotating element pivoted on a support. The compensation device comprises a compensation mobile pivotally mounted on the support and kinematically connected to the rotating element, the device also comprises an elastic return element, a first elastic end of which is eccentrically mounted on the compensation mobile to exert a force on the compensation mobile, the intensity and lever arm of which vary as a function of the angular position of the rotating element. According to an original aspect, a second end of the elastic return element is mounted on the support or on a second compensation mobile pivotally mounted on the support and kinematically connected to the rotating element. With this arrangement, it is possible to select the characteristics of the device in such a way that the resulting torque on the rotating element compensates, over a functional angular range, for the torque due to the unbalance.

This device makes it possible to reproduce a quasi-sinusoidal compensation torque without applying any radial force to the rotating element, while remaining particularly simple, reliable, compact and low inertia.

According to an advantageous aspect, the stable equilibrium position of the rotating element, where the torque due to the unbalance is zero, corresponds to an unstable equilibrium position for the compensation device.

According to an advantageous aspect, the position where the torque due to the unbalance is zero corresponds to a position of maximum tension of the elastic return element.

According to a particularly advantageous aspect of the invention, the compensating mobile is kinematically connected to the rotating element with a drive ratio less than one so that a given angular displacement of the rotating element generates a smaller angular displacement of the compensating mobile.

According to an advantageous aspect, the elastic return element is mounted between two compensating mobiles having identical drive ratios with the rotating element, so that the angular displacements of the two compensating wheels are equal or opposite.

According to an advantageous aspect, the elastic return element is mounted between two compensating mobiles pivoting in the same direction, and the drive ratio is between 0.6 and 0.9

According to another advantageous aspect, the elastic return element is mounted between two compensating mobiles pivoting in opposite directions, and the drive ratio is between 0.2 and 0.8.

### BRIEF DESCRIPTION OF THE DRAWINGS

Further details of the invention will become apparent from the following description, made with reference to the appended drawings in which:

FIG. 1 shows a kinematic diagram of a compensation device according to the invention,

FIG. 2 shows a schematic diagram of a first variant of the compensation device according to the invention,

FIG. 3 shows a schematic diagram of a second variant of a compensation device according to the invention,

FIGS. 4 to 6 show respectively the values of the lever arm, tension and compensation torque as a function of the angle of the rotating element for a given configuration of the first variant,

FIGS. 7 to 9 show different compensation torque curves obtained with different drive ratios for a compensation device according to the first or second variant,

FIG. 10 shows a schematic diagram of a third variant of the compensation device according to the invention,

FIGS. 11 to 13 show different compensation torque curves obtained with different drive ratios for a compensation device according to the third variant.

### EMBODIMENTS OF THE INVENTION

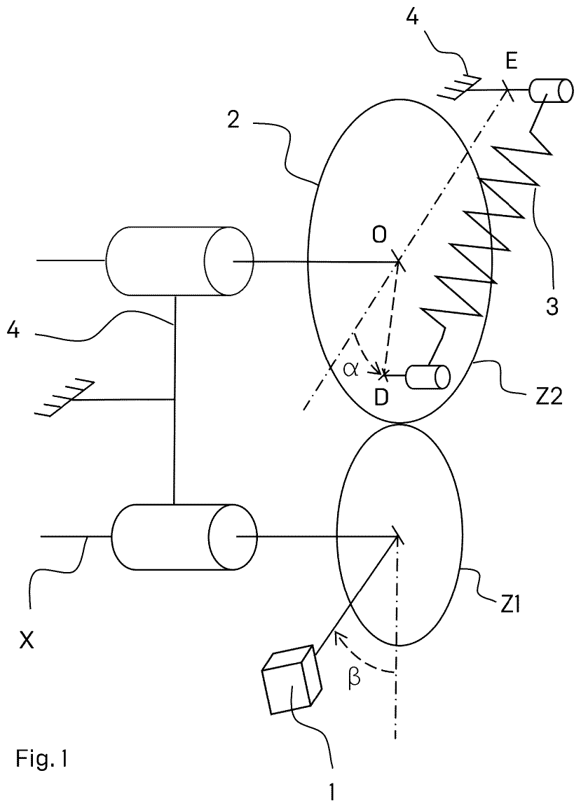

FIG. 1 shows the kinematic diagram of a gravity compensation device according to a first embodiment of the invention. The compensation device is mounted on a support 4, in particular on a machine tool or measuring machine. A rotating element 1 is pivotally mounted about an axis X of the support 4. The rotating element 1 is not balanced on its axis of rotation and has an unbalance which the compensation device is designed to compensate. The compensation device is designed to compensate for the rotary element's unbalance for rotations not exceeding +/−180° around the rotary element's equilibrium position, i.e. when its center of gravity G is vertical, below the axis of rotation X. In practice, the angular amplitude of the rotating element is preferably limited by stops and is less than 360°. The device is adapted to provide compensation torque over a functional angular range encompassing the angular amplitude of the rotating element.

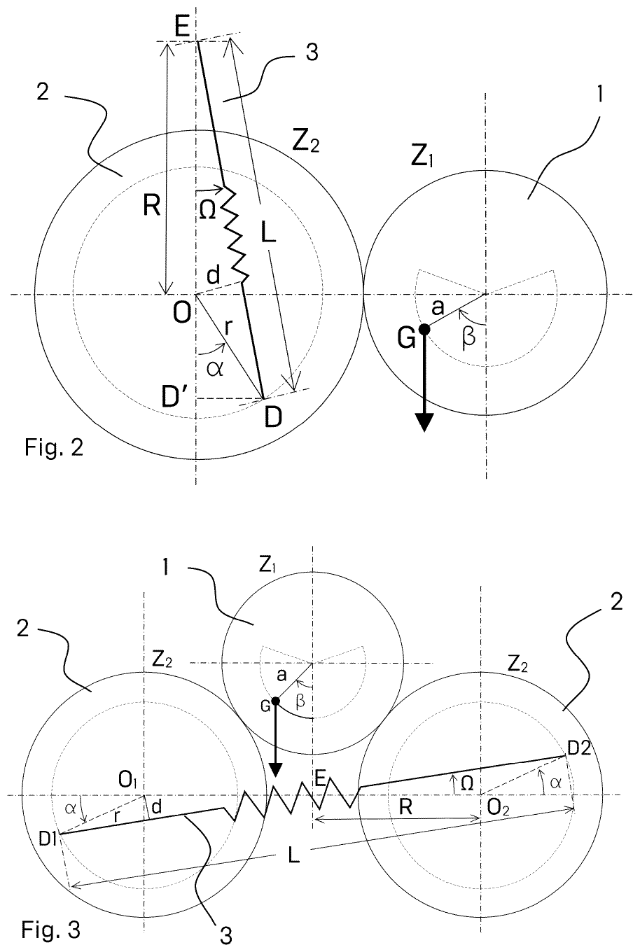

The rotating element 1 has a mass whose center of gravity G is located at a distance a from the axis of rotation X as shown in the diagram in FIG. 2. The torque due to the unbalance of the rotating element 1 is a sinusoidal function of the angle β between the vertical and the plane containing the axis of rotation X and the center of gravity G. If m is the mass of rotating element 1 and g is gravity, the torque Cb due to unbalance is equal to:

$$Cb = m \cdot g \cdot a \cdot sin β$$

The torque due to unbalance Cb is zero when the center of gravity is vertical to the X axis and maximum when it is horizontal, with reference to FIGS. 2, 3 and 10. The compensation device according to the invention aims to deliver a compensation torque Cc, opposite to torque Cb, in order to eliminate the disadvantages of unbalance without significantly increasing inertia.

The compensating device comprises a compensating mobile 2 pivotally mounted on the support 4 and kinematically connected to the rotating element 1. In the embodiment shown, the compensating mobile 2 is provided with a toothing Z2 meshing with a toothing Z1 of the rotating element 1, but other connecting means would be suitable, such as a chain or a toothed belt. A first end of an elastic return element 3 is eccentrically mounted on the compensating mobile 2. Typically, the elastic return element consists of a tension spring, one end of which is attached to the compensating mobile 2, preferably in a pivoting manner. In a first variant shown in FIGS. 1 and 2, a second end of the elastic return element 3 is attached to the support 4, preferably in a pivoting manner. The elastic return element 3 exerts a tensile force on the attachment point D of the compensating mobile 2 in the direction of the second attachment point E, generating a restoring torque Cra on the compensating mobile, which transmits a compensating torque Cc to the rotating element 1 via the gear teeth Z1, Z2.

The axis of rotation of the compensating mobile 2 may not be parallel to the axis of rotation of the rotating element, without departing from the scope of the invention. For example, space-saving considerations could lead to a preference for positioning the compensating mobile perpendicularly to the rotating element, and to the use of bevel gears.

When the rotating element 1 is in a stable equilibrium position, its center of gravity is in a low position vertical to the X axis, i.e. the angle β and the torque due to the unbalance Cb are zero. This position corresponds to an unstable equilibrium position for the compensation device, in which the tension of the elastic return element 3 is at its maximum, and in which the direction of the restoring force passes through the axis of rotation of the compensation mobile 2. This means that the return torque Cra and the compensation torque Cc are also zero.

The diagram in FIG. 2 shows the geometrical elements of the compensation device shown in FIG. 1. The first end of the elastic return element 3 is fixed in D at a distance r from the center of rotation O of the compensating mobile 2.

The second end is fixed at E to the support 4, at a distance R from the point O.

The return torque Cra exerted on the compensating mobile 2 is the product of the lever arm d and the tension T of the tension spring, which in turn depends on the length L between the spring attachment points E and D.

$$Cra = T \cdot d$$

If Z1 and Z2 are the respective numbers of teeth of the Z1 and Z2 toothing, the drive ratio Re between the rotating element and the compensating mobile is:

$$Re = \frac{Z 1}{Z 2}$$

The angle of rotation a of the compensating mobile can be deduced from the angle of inclination β of the rotating element 1:

$$α = Re \cdot β$$

In the triangle EDD′, we have the relationship:

$$Tan Ω = \frac{DD ′}{ED ′} = \frac{r sin α}{R + r cos α}$$

From this, we deduce the value of Ω as a function of α, and therefore of β:

$$Ω = Ar tan ( \frac{r sin α}{R + r cos α} )$$

This enables us to calculate the lever arm d:

$$d = R cos Ω$$

The length L can be deduced from Ω:

$$cos Ω = \frac{ED ′}{L}$$

$$L = \frac{R + r cos α}{cos Ω}$$

The tension T of the spring depends on its stiffness K, its elongation, the difference between its length L and its no-load length Lo, and its no-load tension To:

$$T = ( L - L 0 ) K + To$$

This enables us to calculate the compensating torque Cc as a function of the angle β:

$$Cc = \frac{Z 2}{Z 1} Cra$$

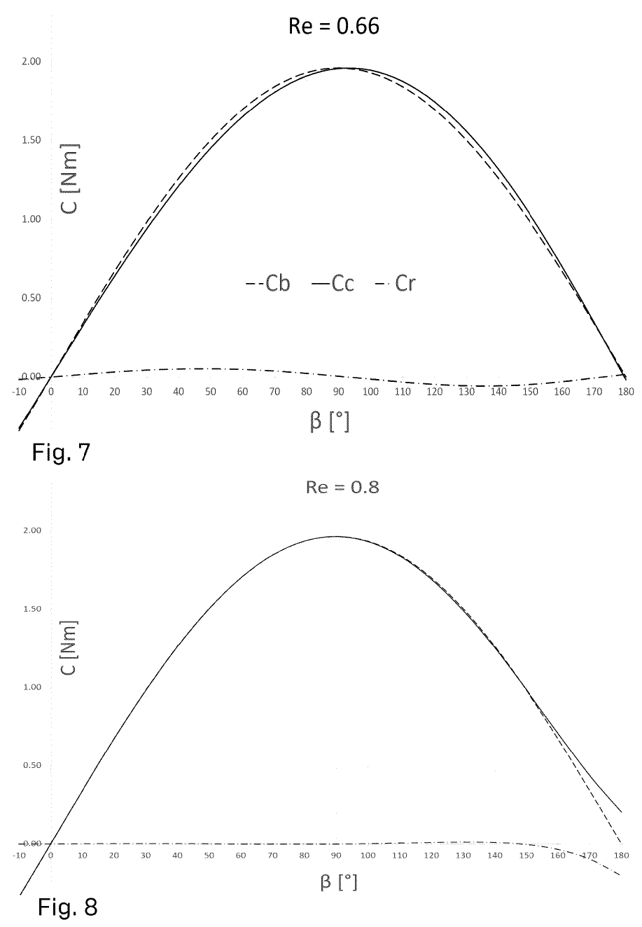

In all the examples shown in FIGS. 4 to 9 and 10 to 13, several dimensions of the device have been arbitrarily set to illustrate the influence of certain parameters on the compensation torque. Thus, for the rotating element 1, an unbalance of 5 kg with an eccentricity a of 40 mm and for the compensation device, distances R and r of 50 mm and 22.5 mm respectively have been set.

In a first example shown in FIGS. 4 to 6, the drive ratio

$$Re = \frac{Z 1}{Z 2}$$

has been set to ¾. The characteristics of the spring that best compensate for the unbalance of the rotating element 1 are then determined. A spring with an unloaded length of 37 mm, a stiffness K of 6.16 N/mm and an unloaded tension To of 1.2 N gives the values shown in the table below and illustrated by the graphs in FIGS. 4 to 6. The values of lever arm d, tension T, and compensating torque Cc are expressed as a function of the values of angle β, which varies in steps of ten from zero to 180°. Throughout FIGS. 6 to 9 and 11 to 13, unbalance torque Cb, compensation torque Cc and residual torque Cr are shown as a function of angle β, in dashed, solid and mixed lines respectively.

| | | | | | | | | | | | |
|---|---|---|---|---|---|---|---|---|---|---|---|
| Angle of inclination β | ° | 0 | 10 | 20 | 30 | 40 | 50 | 60 | 70 | 80 | 90 |
| of the rotating element | | | | | | | | | | | |
| Torque Cb due to | Nm | 0.00 | 0.34 | 0.67 | 0.98 | 1.26 | 1.50 | 1.70 | 1.84 | 1.93 | 1.96 |
| unbalance | | | | | | | | | | | |
| Tension T of the elastic | N | 114 | 113 | 112 | 110 | 107 | 103 | 98 | 93 | 87 | 80 |
| return element | | | | | | | | | | | |
| Lever arm d | mm | 0 | 2 | 4 | 6 | 8 | 10 | 12 | 13 | 15 | 17 |
| Compensating torque Cc | Nm | 0.00 | 0.34 | 0.66 | 0.97 | 1.25 | 1.49 | 1.69 | 1.84 | 1.93 | 1.96 |
| Residual torque Cr | Nm | 0.000 | 0.006 | 0.011 | 0.014 | 0.015 | 0.015 | 0.012 | 0.008 | 0.002 | −0.003 |
| Angle of inclination β | ° | 100 | 110 | 120 | 130 | 140 | 150 | 160 | 170 | 180 | |
| of the rotating element | | | | | | | | | | | |
| Torque Cb due to | Nm | 1.93 | 1.84 | 1.70 | 1.50 | 1.26 | 0.98 | 0.67 | 0.34 | 0.00 | |
| unbalance | | | | | | | | | | | |
| Tension T of the elastic | N | 73 | 65 | 56 | 47 | 38 | 28 | 19 | 9 | 0 | |
| return element | | | | | | | | | | | |
| Lever arm d | mm | 18 | 19 | 20 | 21 | 22 | 22 | 22 | 22 | 21 | |
| Compensating torque Cc | Nm | 1.94 | 1.85 | 1.71 | 1.51 | 1.26 | 0.98 | 0.67 | 0.36 | 0.07 | |
| Residual torque Cr | Nm | −0.007 | −0.009 | −0.009 | −0.005 | 0.000 | 0.004 | 0.000 | −0.019 | −0.067 | |

Surprisingly, it is possible to reproduce a pseudo-sinusoidal compensation torque very close to the sinusoidal torque due to unbalance, as shown in FIG. 6. In the example shown, over a range of +/−160°, the maximum value of the residual torque represents only 0.7% of the maximum torque without compensation. The figures represent the compensating torque for positive values of β, it being understood that the device behaves symmetrically for negative values of β.

FIGS. 4 and 5 show lever arm d and tension T as a function of angle β, respectively. The value d of the lever arm is zero for an angle β of zero, increases up to the value of r where the segment [OD] is perpendicular to the segment [DE], and then decreases. The value of the tension T is maximal for an angle β of zero, then decreases constantly. The product d. T, proportional to the compensation torque, has a zero value at zero angle β, passes through a maximum and then decreases as the tension on the elastic return element relaxes. It is preferable for the compensation torque to be closest to the unbalance torque when the latter is highest, i.e. for values of angle β close to 90°. It is therefore important to center the pseudo sinusoid so that its maximum is obtained for an angle β of 90°. The parameters with the greatest influence on the position of this maximum are the spring's open length Lo, the drive ratio and the distance R defining the position of the second end of the elastic return element. The no-load length affects the decrease in tension T as a function of the angle β. The greater the no-load length, the faster the spring tension decay occurs, and the more the peak of the pseudo-sine wave moves towards the lower values of β. The drive ratio defines the position of the maximum lever arm as a function of β. The lower the drive ratio, the later the maximum of the lever arm occurs and the more the peak of the pseudo sinusoid moves towards the larger values of β. Once the pseudo sinusoid is centered on the β value of 90°, adjustment of the no-load tension and stiffness enables the sinusoidal curve of the torque due to unbalance to be approximated.

Prior art devices aim to reproduce the sinusoidal torque due to gravity by applying a constant force or one that varies as little as possible to an action point mounted directly on the rotating element or to a mobile kinematically connected to the rotating element with a drive ratio of one to one. In an original way, the device of the present invention allows to simulate a sinusoidal torque by exploiting the joint variations of the lever arm and the tension as a function of the angular position of the rotating element.

The compensation device of the invention can be used to compensate for the unbalance of a rotating element with a limited angular amplitude not exceeding +/−180° around its equilibrium position. If the geometrical characteristics of the device and the angular amplitude of the rotating element are fixed, the drive ratio can be used to define the minimum length reached by the spring when the rotating element 1 is in abutment. This determines the useful stroke of the spring element and its maximum no-load length, which should preferably be less than this minimum length so that the spring always remains under tension.

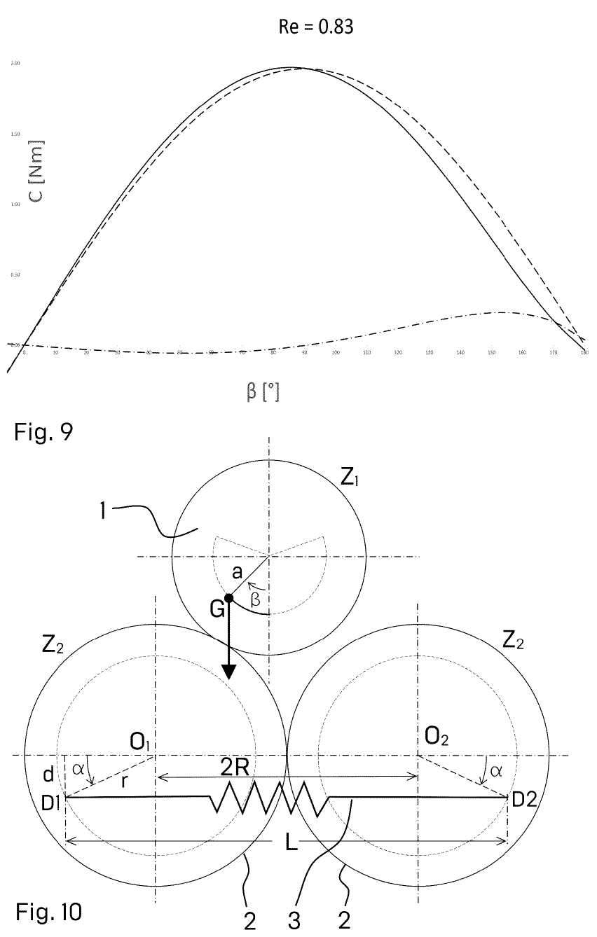

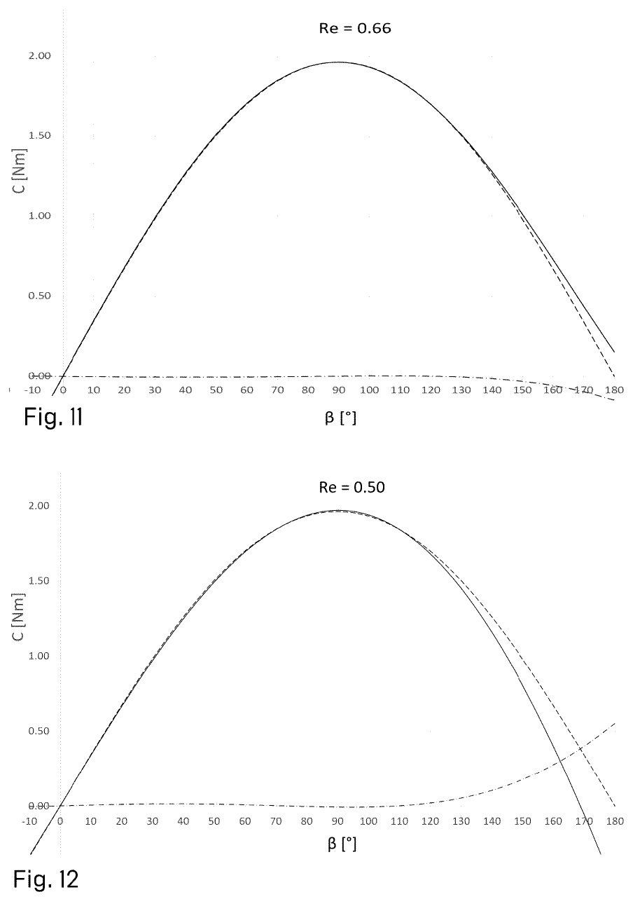

FIGS. 7 to 9 illustrate the compensations obtained for drive ratios of ⅔, ⅘ and ⅚ respectively, for which the characteristics of the elastic return element-stiffness, no-load length and no-load tension—have been adapted. Note that the peak of the compensation curve is obtained for a value of β slightly greater than 90° in the case of FIG. 7 and slightly less in that of FIG. 10.

In the examples shown corresponding to the first variant of the invention, values of the drive ratio Re between 0.7 and 0.8 provide the best compensation curves. However, the values of R and r have been fixed arbitrarily, whereas it would also be possible to vary these parameters, so that it is not possible to characterize the invention in a simple way by providing ranges of values for each parameter. Generally speaking, in the case of the first two variants of the invention, it is possible to obtain gravity compensation over at least part of the angular range +/−180° for drive ratio values between 0.6 and 0.9.

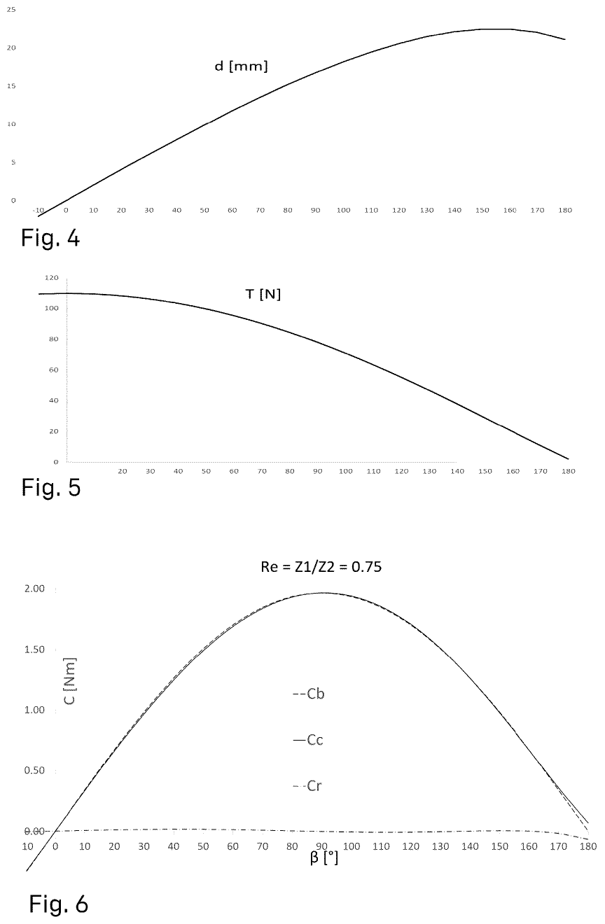

FIG. 3 schematically illustrates a second variant which comprises two compensating mobiles 2 carrying Z2 teeth of the same diameter meshing with the Z1 teeth of the rotating element 1. The two compensating mobiles have identical drive ratios to the rotating element, so that their angular displacements are equal, i.e. of the same value and direction. The second end of the spring element 3 is not attached to the support 4, as in the previous variant, but to the second compensation mobile. Attaching a single spring between points D1 and D2 is equivalent to attaching two springs to the central point E, and this variant is kinematically equivalent to the previous one. The single-spring solution saves on the second pin for attachment to support 4 and increases the useful length of the spring, which would otherwise have been lost by the means of attachment to support 4.

The diagram in FIG. 10 shows a third variant of a compensating device according to the invention, also comprising two compensating mobiles 2, this time mounted in series rather than in parallel, so that the two compensating mobiles rotate in opposite directions, with one compensating mobile acting as an inverter for the other. In the example shown, the drive ratios with the rotating element are identical for the two compensating mobiles, so that their angular displacements are opposite, i.e. of the same value and in opposite directions. It is understood that the two compensating mobiles are not necessarily in direct engagement, and that a reversing wheel could be mounted between the rotating element 1 and one of the compensating mobiles, or any other arrangement enabling the direction of rotation of this compensating mobile to be reversed with respect to the first moving part. An elastic return element 3 is mounted between the two compensating mobiles 2, so that the attachment points D1, D2 are aligned with the centers O1, O2 of the compensating mobiles 2 when the angle β is zero. In this configuration, the segment [D1D2] is always parallel to the line of centers [O1O2].

The lever arm d is expressed simply as:

$$d = r sin α$$

If 2R is the distance between centers O1 and O2, the length L between hook points D1 and D2 is expressed as follows:

$$L = 2 ( R + r cos α )$$

For the same drive ratio, the increase in lever arm d and the reduction in length L as a function of angle β are faster in this 3rd variant than in the previous two. The maximum value r of the lever arm occurs at an angle α equal to 90° in this third variant, whereas it was greater than 90° in the first two variants. As a result, this variant is suitable for lower drive ratios Re, which will limit the elongation of the elastic return element 3 and optimize its fatigue resistance. On the other hand, the lower drive ratio values do not allow compensation over a wide angular range. Generally speaking, in the case of this third variant of the invention, it is possible to obtain gravity compensation over at least part of the angular range +/−180° for drive ratio values between 0.2 and 0.8.

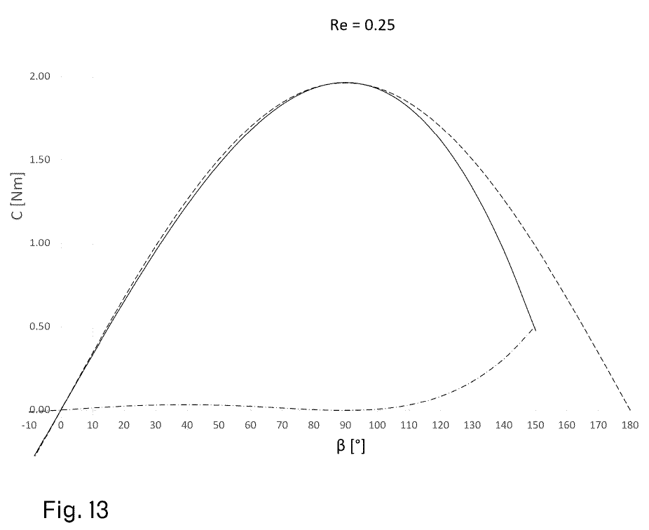

FIGS. 11 to 13 illustrate examples of compensating torque obtained with the third variant for different drive ratios, maintaining the same values of R and r as in the previous examples.

In the examples shown, the two compensating gears are identical, but they could also have different drive ratios and different eccentricities r without departing from the scope of the invention.

1. A gravity compensation device, in particular for a machine tool or measuring machine, intended to compensate for the unbalance of a rotating element (1) pivoted on a support (4), the device comprising a compensating mobile (2) pivotally mounted on the support (4) and kinematically connected to the rotating element (1), the device also comprising an elastic return element (3), a first end of which is eccentrically mounted directly on the compensating mobile (2), in order to exert a force on the compensating mobile, the intensity and lever arm of which vary as a function of the angular position of the rotating element, wherein a second end of the elastic return element (3) is mounted on the support (4) or on a second compensating mobile (2) pivotally mounted on the support (4) and kinematically connected to the rotating element (1), the characteristics of the device being chosen so that the resulting torque on the rotating element compensates, over a functional angular range, for the torque due to the unbalance.

2. The device according to claim 1 wherein the stable equilibrium position of the rotating element (1) where the torque due to the unbalance is zero corresponds to an unstable equilibrium position of the compensation device.

3. The device according to claim 1 wherein the stable equilibrium position of the rotating element (1) where the torque due to the unbalance is zero corresponds to a position of maximum tension of the elastic return element (3).

4. The device as claimed in claim 1 wherein the drive ratio between the rotating element (1) and the compensating mobile (2) is less than one so that a given angular displacement of the rotating element (1) generates a smaller angular displacement of the compensating mobile (2).

5. The device according to claim 1 wherein the elastic return element (3) is mounted between two compensating mobiles (2) having identical drive ratios with the rotary element (1) so that the angular displacements of the two compensating mobiles are equal or opposite.

6. The device according to claim 1 wherein the elastic return element (3) is mounted between two compensating mobiles (2) pivoting in the same direction.

7. The device according to claim 1 wherein the drive ratio between the rotating element (1) and the compensating mobile (2) is between 0.6 and 0.9.

8. The device according to claim 1 wherein the elastic return element (3) is mounted between two compensating mobiles (2) pivoting in opposite directions.

9. The device according to the preceding claim wherein the drive ratio between the rotating element (1) and the compensating mobile (2) is between 0.2 and 0.8.

10. The device according to claim 1 wherein the elastic return element (3) is mounted between two compensating mobiles (2) having different drive ratios with the rotary element (1).

11. A machine tool or measuring machine wherein it comprises a compensation device according to claim 1.
